(19) United States
(12) Patent Application Publication
(10) Pub. No.: US 2026/0212641 A1
(43) Pub. Date: Jul. 23, 2026

(54) CONTROL METHOD, WEARABLE DEVICE AND NON-TRANSITORY COMPUTER READABLE STORAGE MEDIUM

(71) Applicant: HTC Corporation, Taoyuan City (TW)

(72) Inventor: Ying-Wen CHEN, Taoyuan City (TW)

(21) Appl. No.: 19/035,775

(22) Filed: Jan. 23, 2025

(51) Int. Cl. G06V 10/75; G06V 10/28

(52) U.S. Cl. CPC G06V 10/758; G06V 10/28

(57) ABSTRACT

The present disclosure provides a control method and a wearable device. The wearable device is operable by a user, and includes a supplemental lighting system, a camera and a processor. The control method includes: by the camera, capturing an image frame related to a hand of the user; by the processor, generating at least one indicator according to the image frame; and by the processor, selectively maintaining an enablement of the supplemental lighting system based on the at least one indicator indicating whether a hand image in the image frame is distinguishable against a background image of the image frame.

### BACKGROUND

### Field of Invention

This disclosure relates to a method and a device, and in particular to a control method and a wearable device.

### Description of Related Art

These days, some related arts apply supplemental light sources to hand tracking systems to overcome low lighting conditions. However, these related arts do not notice that the supplemental light sources sometimes lead to a decrease in the quality of images, which further affects hand tracking. Therefore, it is necessary to propose new approaches for overcoming the low lighting conditions and ensuring the reliability of hand tracking.

### SUMMARY

An aspect of present disclosure relates to a control method. The control method is configured to control a supplemental lighting system of a wearable device operable by a user, and includes: by a camera of the wearable device, capturing an image frame related to a hand of the user; by a processor of the wearable device, generating at least one indicator according to the image frame; and by the processor, selectively maintaining an enablement of the supplemental lighting system based on the at least one indicator indicating whether a hand image in the image frame is distinguishable against a background image of the image frame.

Another aspect of present disclosure relates to a wearable device. The wearable device is operable by a user, and includes a supplemental lighting system, a camera and a processor. The supplemental lighting system is configured to emit a supplemental light. The camera is configured to capture an image frame related to a hand of the user. The processor is coupled to the supplemental lighting system and the camera, and is configured to: generate at least one indicator according to the image frame; and selectively maintain an enablement of the supplemental lighting system based on the at least one indicator indicating whether a hand image in the image frame is distinguishable against a background image of the image frame.

Another aspect of present disclosure relates to a non-transitory computer readable storage medium with a computer program to execute a control method, wherein the control method is configured to control a supplemental lighting system of a wearable device operable by a user, and includes: by a camera of the wearable device, capturing an image frame related to a hand of the user; by a processor of the wearable device, generating at least one indicator according to the image frame; and by the processor, selectively maintaining an enablement of the supplemental lighting system based on the at least one indicator indicating whether a hand image in the image frame is distinguishable against a background image of the image frame.

It is to be understood that both the foregoing general description and the following detailed description are by examples, and are intended to provide further explanation of the invention as claimed.

### BRIEF DESCRIPTION OF THE DRAWINGS

The present disclosure can be more fully understood by reading the following detailed description of the embodiment, with reference made to the accompanying drawings as follows:

FIG. 1 is a block diagram of a wearable device operable by a user in accordance with some embodiments of the present disclosure;

FIG. 2 is a flow diagram of a control method of the wearable device in accordance with some embodiments of the present disclosure;

FIG. 3 is a schematic diagram of two image frames captured by the wearable device in accordance with some embodiments of the present disclosure;

FIG. 4 is a schematic diagram of two statistical results corresponding to the two image frames of FIG. 3 in accordance with some embodiments of the present disclosure;

FIG. 5 is a schematic diagram of two statistical results corresponding to one of the two image frames of FIG. 3 and two statistical results corresponding to the other of the two image frames of FIG. 3 in accordance with some embodiments of the present disclosure;

FIG. 6 is another flow diagram of the control method in accordance with some embodiments of the present disclosure;

FIG. 7 is a schematic diagram of another two image frames captured by the wearable device in accordance with some embodiments of the present disclosure; and

FIG. 8 is another flow diagram of the control method in accordance with some embodiments of the present disclosure.

### DETAILED DESCRIPTION

The embodiments are described in detail below with reference to the appended drawings to better understand the aspects of the present application. However, the provided embodiments are not intended to limit the scope of the disclosure, and the description of the structural operation is not intended to limit the order in which they are performed. Any device that has been recombined by components and produces an equivalent function is within the scope covered by the disclosure.

As used herein, “coupled” and “connected” may be used to indicate that two or more elements physical or electrical contact with each other directly or indirectly, and may also be used to indicate that two or more elements cooperate or interact with each other.

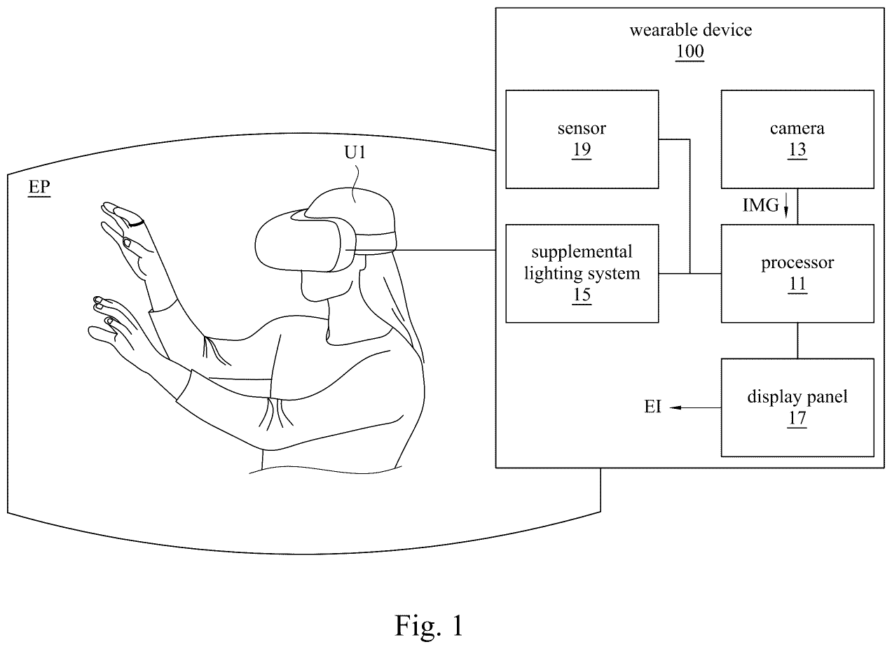

Referring to FIG. 1, FIG. 1 is a block diagram of a wearable device 100 in accordance with some embodiments of the present disclosure. In some embodiments, the wearable device 100 can be implemented by a head mounted display (HMD) of an immersive system, and can be worn on the head of a user U1. As shown in FIG. 1, the wearable device 100 can be operated by the user U1 in a physical environment EP, such as a gaming place, a workplace, a house, etc.

In some embodiments, the wearable device 100 provides an immersive experience for the user U1. For example, the user's perception of the physical environment EP is replaced or embellished with an immersive environment EI as shown in FIG. 1. In particular, the immersive environment EI can correspondingly be an augmented reality (AR) environment, a virtual reality (VR) environment, or a mixed reality (MR) environment. As should be understood, in some embodiments, the immersive environment EI includes at least one virtual object (not shown in the drawings), which cannot be directly seen in the physical environment EP by the user U1.

Moreover, in the above embodiments that the immersive environment EI is the VR, MR or AR environment, the user U1 can control the at least one virtual object in the immersive environment EI by operating at least one controller (not shown) communicatively coupled to the wearable device 100 or by some hand movements of the user U1.

In accordance with the above embodiments that the user U1 controls the at least one virtual object by the hand movements, the wearable device 100 would be configured to track at least one hand of the user U1. In some embodiments, the wearable device 100 tracks the hand of the user U1 indoors. In these cases, the wearable device 100 can provide supplemental illumination in the physical environment EP, to prevent the failure of hand tracking due to the insufficiency of ambient illumination in the physical environment EP. Accordingly, in some embodiments, as shown in FIG. 1, the wearable device 100 includes a processor 11, a camera 13, a supplemental lighting system 15, a display panel 17 and a sensor 19. In particular, the processor 11 is electrically and/or communicatively coupled to the camera 13, the supplemental lighting system 15, the display panel 17 and the sensor 19.

In some embodiments, the sensor 19 is configured to sense an ambient light in the physical environment EP, such as a nature light outside a room, an artificial light produced by a lamp, etc., to generate a sense data related to the ambient light. The processor 11 is configured to selectively activate or turn on the supplemental lighting system 15 according to the sense data received from the sensor 19. For example, when the sense data indicates that the ambient light in the physical environment EP is insufficient, the processor 11 activates the supplemental lighting system 15, and the supplemental lighting system 15 emits a supplemental light extraneous to the ambient light for the physical environment EP, so as to provide the supplemental illumination in the physical environment EP. When the sense data indicates that the ambient light in the physical environment EP is sufficient, the processor 11 deactivates the supplemental lighting system 15, and the supplemental lighting system 15 stops emitting the supplemental light.

In some embodiments, the camera 13 is configured to capture multiple images IMG in the physical environment EP. It should be understood that these images IMG may include at least one of images of the whole or partial physical environment EP and images of physical parts of the user U1 (e.g., the hand of the user U1). The processor 11 is configured to process the images IMG captured by the camera 13 by some image processing algorithms (e.g., an existing hand tracking algorithm), to track the hand of the user U1.

In addition, by applying some feature extraction based localization technologies (e.g., Simultaneous Localization and Mapping (SLAM)) to the images IMG captured by the camera 13, the processor 11 can calculate the position and/or orientation of the wearable device 100 in the physical environment EP. Also, the processor 11 can generate multiple visual contents according to the positions and/or orientation of the wearable device 100. The display panel 17 can display the visual contents generated by the processor 11, so as to provide the immersive environment EI for the user U1.

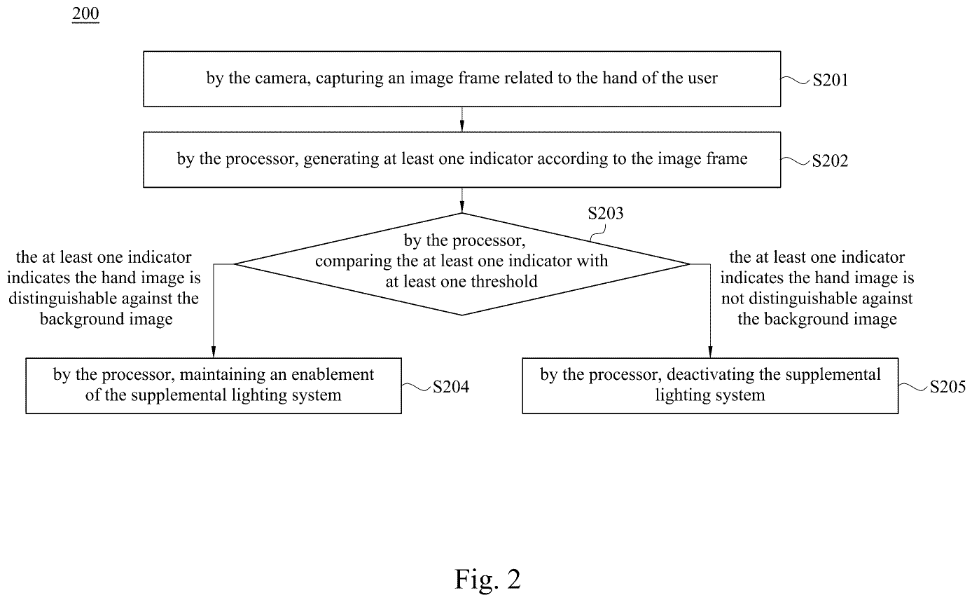

In some practical applications, the result of hand tracking may get worse because of the supplemental illumination provided by the supplemental lighting system 15. For example, other part (e.g., elbow) of the user U1 is illuminated and/or highlighted by the supplemental illumination instead of the hand of the user U1, which may also lead to the failure of hand tracking. Notably, in some embodiments, the wearable device 100 can control the supplemental lighting system 15 to stop emitting the supplemental light when detecting that the result of hand tracking get worse because of the supplemental illumination, which then would be described in detail below with reference to FIG. 2.

FIG. 2 is a flow diagram of a control method 200 applicable to the wearable device 100 in accordance with some embodiments of the present disclosure. In some embodiments, as shown in FIG. 2, the control method 200 includes operations S201-S205. However, the present disclosure should not be limited thereto.

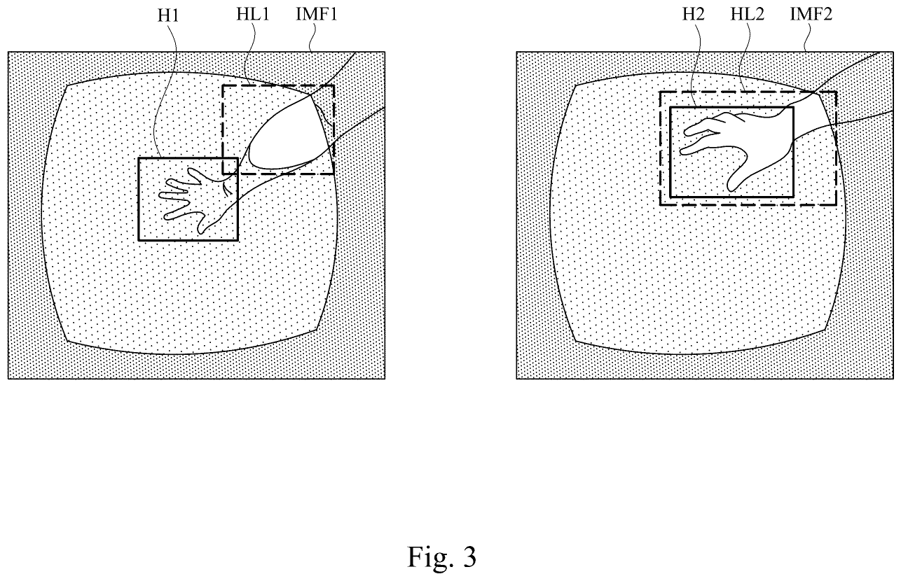

In operation S201, the camera 13 captures an image frame related to the hand of the user U1. Referring to FIG. 3, FIG. 3 is a schematic diagram of an image frame IMF1 and an image frame IMF2, which are captured by the camera 13, in accordance with some embodiments of the present disclosure. In some embodiments, the image frame IMF1 and the image frame IMF2, respectively, include a hand image H1 and a hand image H2, which are corresponding to the hand of the user U1. In addition, the image frame IMF1 and the image frame IMF2 each has a background image, such as an image area on the image frame IMF1 or the image frame IMF2, which is not covered by the images of physical parts of the user U1.

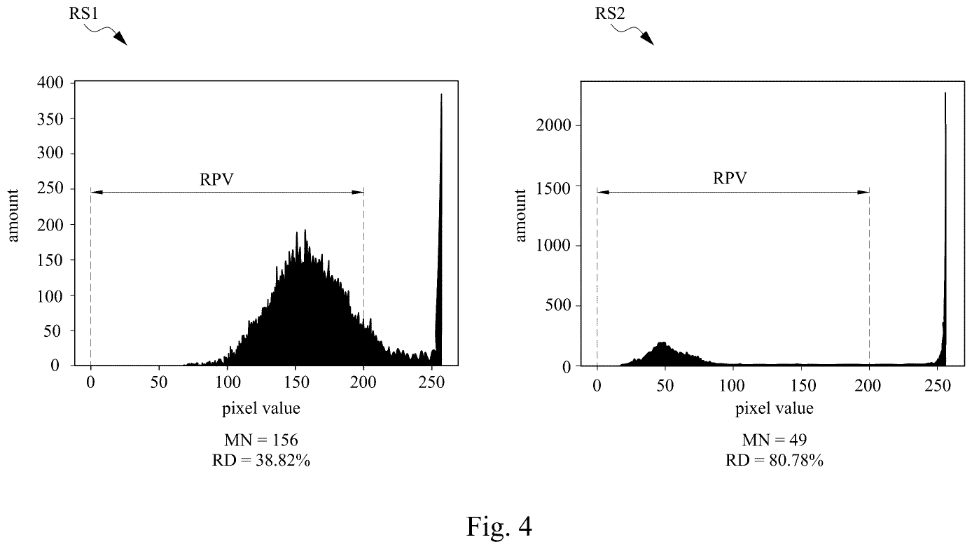

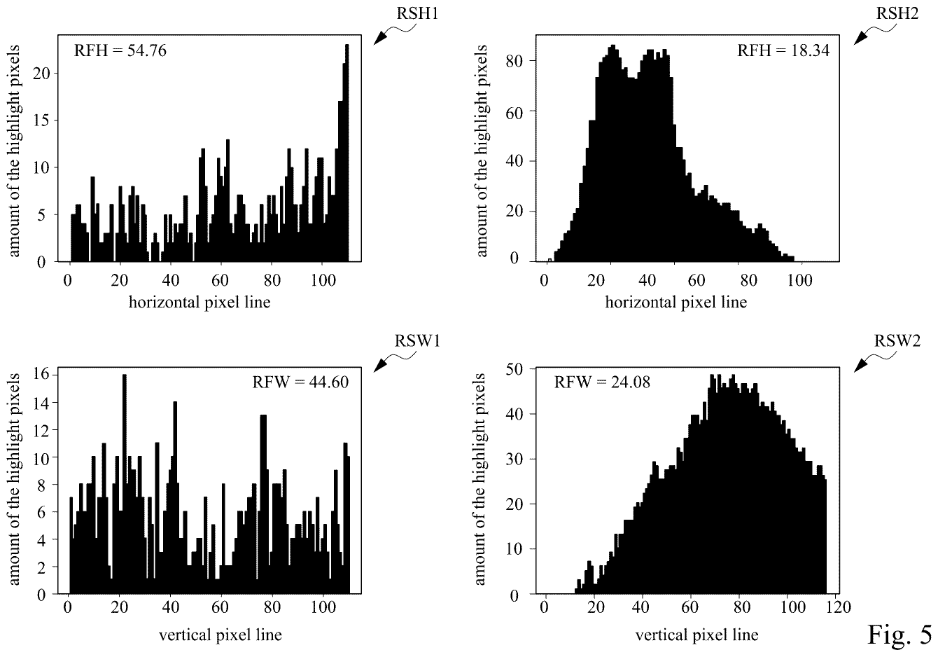

In operation S202, the processor 11 generates at least one indicator according to the image frame, which would be described in detail below with reference to FIGS. 3, 4 and 5. FIG. 4 is a schematic diagram of two statistical results RS1 and RS2 corresponding to the image frames IMF1 and IMF2 of FIG. 3 in accordance with some embodiments of the present disclosure. FIG. 5 is a schematic diagram of two statistical results RSH1 and RSW1 corresponding to the image frame IMF1 of FIG. 3 and two statistical results RSH2 and RSW2 corresponding to the image frame IMF2 of FIG. 3 in accordance with some embodiments of the present disclosure.

In some embodiments of operation S202, the processor 11 counts an amount of every pixel value (e.g., 0 to 255) according to all pixels of the image frame IMF1, to form a histogram as the statistical result RS1. In the statistical result RS1 of FIG. 4, the x-axis of the histogram represents the pixel value, and the y-axis of the histogram represents the amount. That is to say, the processor 11 performs a statistical calculation (e.g., an amount statistic) on the image frame IMF1, to generate the statistical result RS1 indicating the amount of every pixel value. As shown in FIG. 4, the processor 11 obtains a mode MN in a preset pixel value range RPV from the statistical result RS1. The mode MN in the preset pixel value range RPV indicates one pixel value which appears most often in the preset pixel value range RPV. For example, in the statistical result RS1 of FIG. 4, the mode MN in the preset pixel value range RPV ranging from 0 to 200 equals 156. The preset pixel value range RPV should not be limit to a range of 0 to 200.

In accordance with the above descriptions, then, the processor 11 uses an equation (1) to calculate a discrimination rate RD as the at least one indicator. In particular, “255” in the equation (1) is the maximal pixel value in the grayscale image. When the mode MN obtained from the statistical result RS1 equals 156, the discrimination rate RD calculated by the processor 11 using the equation (1) substantially equals 38.82%. From the equation (1), it can be seen that the processor 11 calculates the discrimination rate RD according to the mode MN in the preset pixel value range RPV.

$$RD = ( ( 255 - MN ) / 255 ) \times 100 \% \qquad ( 1 )$$

Referring to the above descriptions of generating the discrimination rate RD according to the image frame IMF1, in some embodiments of operation S202, the processor 11 performs the statistical calculation (e.g., the amount statistic) on the image frame IMF2, to generate the statistical result RS2 indicating the amount of every pixel value. The processor 11 obtains the mode MN (i.e., 49 as shown in FIG. 4) in the preset pixel value range RPV from the statistical result RS2. Then, the processor 11 calculates the discrimination rate RD (i.e., 80.78% as shown in FIG. 4) according to the mode MN in the preset pixel value range RPV.

In some embodiments of operation S202, the processor 11 counts an amount of highlight pixels in each horizontal pixel line of the image frame IMF1, to form a histogram as the statistical result RSH1. In particular, the highlight pixel may be defined by the pixel having the pixel value higher than a preset highlight threshold (e.g., 250). In the statistical result RSH1 of FIG. 5, the x-axis of the histogram represents the horizontal pixel line, and the y-axis of the histogram represents the amount of highlight pixels. Moreover, the processor 11 counts an amount of highlight pixels in each vertical pixel line of the image frame IMF1, to form another histogram as the statistical result RSW1. In the statistical result RSW1 of FIG. 5, the x-axis of the histogram represents the vertical pixel line, and the y-axis of the histogram represents the amount of highlight pixels. From the statistical results RSH1 and RSW1, it can be roughly seen how all highlight pixels of the image frame IMF1 are distributed. That is to say, the processor 11 performs a statistical calculation (e.g., an amount statistic) on the image frame IMF1, to generate the statistical results RSH1 and RSW1 indicating an amount and a distribution of all highlight pixels in the image frame IMF1.

After the statistical results RSH1 and RSW1 are generated, the processor 11 obtains a first mode and a second mode from the statistical results RSH1 and RSW1, respectively. The first mode obtained from the statistical result RSH1 indicates one horizontal pixel line which has the most highlight pixels. Also, the second mode obtained from the statistical result RSW1 indicates one vertical pixel line which has the most highlight pixels.

In accordance with the above descriptions, then, the processor 11 uses an equation (2) and an equation (3) to calculate two focus rates RFH and RFW as the at least one indicator. In particular, “MNH” in the equation (2) and “MNW” in the equation (3) are the first mode obtained from the statistical result RSH1 and the second mode obtained from the statistical result RSW1, respectively. “NH (y)” in the equation (2) is the amount of highlight pixels in one particular horizontal pixel line, in which “y” in the equation (2) ranges from 1 to HEI (i.e., the vertical length of pixels of the image frame IMF1). “NW (x)” in the equation (3) is the amount of highlight pixels in one particular vertical pixel line, in which “x” in the equation (3) ranges from 1 to WID (i.e., the horizontal length of pixels of the image frame IMF1). Also, “NT” in the equations (2) and (3) is a total amount of the highlight pixels in the image frame IMF1. By the equations (2) and (3), the processor 11 calculates the focus rates RFH and RFW according to the first mode, the second mode and the statistical results RSH1 and RSW1. For example, in FIG. 5, the focus rate RFH corresponding to the statistical result RSH1 substantially equals 54.76, and the focus rate RFW corresponding to the statistical result RSW1 substantially equals 44.60.

$$RFH = \sqrt{{\sum }_{y = 1}^{y = HEI} {( y - MNH )}^{2} \times NH ( y ) / NT} \qquad ( 2 )$$

$$RFW = \sqrt{{\sum }_{x = 1}^{x = WID} {( x - MNW )}^{2} \times NW ( x ) / NT} \qquad ( 3 )$$

Referring to the above descriptions of generating the focus rates RFH and RFW according to the image frame IMF1, in some embodiments of operation S202, the processor 11 performs the statistical calculation (e.g., the amount statistic) on the image frame IMF2, to generate the statistical results RSH2 and RSW2 indicating an amount and a distribution of all highlight pixels in the image frame IMF2. The processor 11 obtains a third mode and a fourth mode from the statistical results RSH2 and RSW2, respectively. Then, the processor 11 calculates a focus rate RFH (i.e., 18.34 as shown in FIG. 5) and a focus rate RFW (i.e., 24.08 as shown in FIG. 5) according to the third mode, the fourth mode and the statistical results RSH2 and RSW2.

In operation S203, the processor 11 compares the at least one indicator with at least one threshold. In some embodiments, the at least one indicator includes the discrimination rate RD generated according to the image frame IMF1 or the image frame IMF2. In these cases, the processor 11 compares the discrimination rate RD with a discrimination rate threshold (not shown) of the at least one threshold. In particular, the discrimination rate threshold is preset according to the scenario of the wearable device 100. In some embodiments, the discrimination rate RD (i.e., 38.82%) generated according to the image frame IMF1 is not higher or is lower than the discrimination rate threshold, which indicates that the hand image H1 is not distinguishable against the background image of the image frame IMF1. That is to say, the hand of the user U1 may be too close to a physical object (e.g., a wall) in the physical environment EP, in which the physical object is corresponding to the background image. In some embodiments, the discrimination rate RD (i.e., 80.78%) generated according to the image frame IMF2 is higher than the discrimination rate threshold, which indicates that the hand image H2 is distinguishable against the background image of the image frame IMF2. That is to say, the hand of the user U1 and the physical object which corresponds to the background image are spaced by an appropriate distance.

In some embodiments, the at least one indicator includes the focus rates RFH and RFW generated according to the image frame IMF1 or the image frame IMF2. In these cases, the processor 11 compares the focus rates RFH and RFW with a focus rate threshold (not shown) of the at least one threshold. In particular, the focus rate threshold is preset according to the scenario of the wearable device 100. In some embodiments, at least one the focus rate RFH (i.e., 54.76) and the focus rate RFW (i.e., 44.60) generated according to the image frame IMF1 is not lower or is higher than the focus rate threshold, which indicates that the hand image H1 is not distinguishable against the background image of the image frame IMF1. In some embodiments, both the focus rate RFH (i.e., 18.34) and the focus rate RFW (i.e., 24.08) generated according to the image frame IMF2 are lower than the focus rate threshold, which indicates that the hand image H2 is distinguishable against the background image of the image frame IMF2.

In some further embodiments, when the discrimination rate RD (e.g., 80.78% calculated according to the image frame IMF2) is higher than the discrimination rate threshold as well as both the focus rate RFH (e.g., 18.34 calculated according to the image frame IMF2) and the focus rate RFW (e.g., 24.08 calculated according to the image frame IMF2) are lower than the focus rate threshold, the processor 11 determines that the hand image (e.g., the hand image H2 of the image frame IMF2) is distinguishable against the background image. Otherwise, the processor 11 determines that the hand image (e.g., the hand image H1 of the image frame IMF1) is not distinguishable against the background image.

Furthermore, in some embodiments of FIG. 3, the elbow of the user U1 is illuminated and/or highlighted by the supplemental illumination instead of the hand of the user U1. Therefore, in the image frame IMF1 of FIG. 3, the hand image H1 is nearly not within a highlight area HL1, and the hand image H1 and the background image are similar in color or grayscale. The hand image H1 and the background image similar in color or grayscale possibly causes the failure of hand tracking. Accordingly, the discrimination rate RD (i.e., 38.82%) generated according to the image frame IMF1 is not higher or is lower than the discrimination rate threshold, and/or at least one of the focus rate RFH (i.e., 54.76) and the focus rate RFW (i.e., 44.60) generated according to the image frame IMF1 is not lower or is higher than the focus rate threshold.

In some embodiments of FIG. 3, the hand of the user U1 is illuminated and/or highlighted by the supplemental illumination. Therefore, in the image frame IMF2 of FIG. 3, the hand image H2 is fully within a highlight area HL2. Accordingly, the discrimination rate RD (i.e., 80.78%) generated according to the image frame IMF2 is higher than the discrimination rate threshold, and/or both the focus rate RFH (i.e., 18.34) and the focus rate RFW (i.e., 24.08) generated according to the image frame IMF2 are lower than the focus rate threshold.

In some embodiments, as shown in FIG. 2, when the at least one indicator indicates the hand image is distinguishable against the background image, operation S204 is executed. When the at least one indicator indicates the hand image is not distinguishable against the background image, operation S205 is executed.

In operation S204, the processor 11 maintains an enablement of the supplemental lighting system 15. That is to say, if the supplemental lighting system 15 is emitting the supplemental light before operation S204, the processor 11 keeps the supplemental lighting system 15 emitting the supplemental light in operation S204.

In operation S205, the processor 11 deactivates the supplemental lighting system 15. That is to say, if the supplemental lighting system 15 is emitting the supplemental light before operation S205, the processor 11 controls the supplemental lighting system 15 to stop emitting the supplemental light in operation S205.

As can be seen from the descriptions of FIG. 2, by the at least one indicator generated according to the image frame, the wearable device 100 can detect if the result of hand tracking may get worse because of the supplemental illumination, and turns off the supplemental lighting system 15 when detecting the result of hand tracking may get worse because of the supplemental illumination. Therefore, the reliability of the hand tracking is increased.

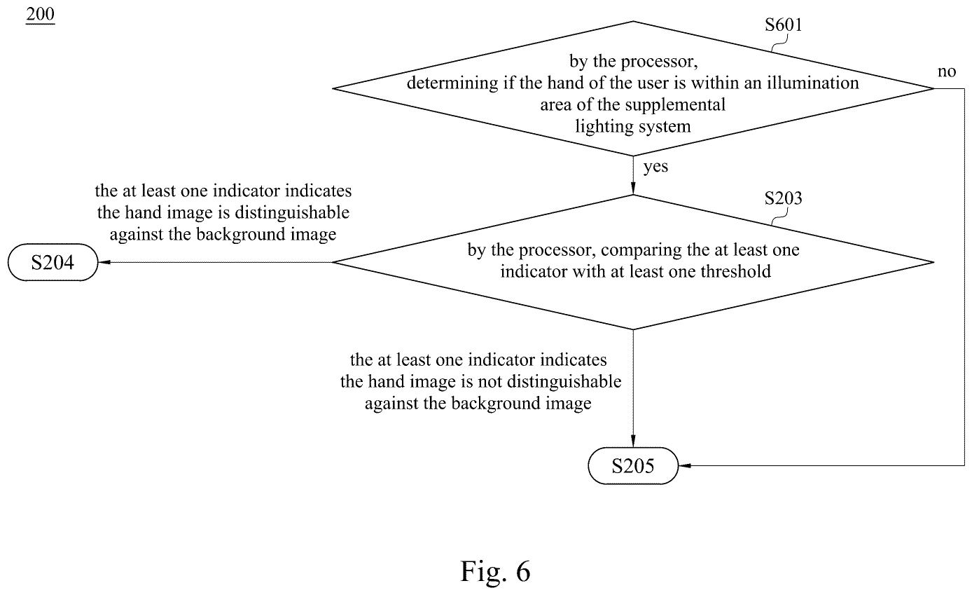

It should be understood that the control method 200 is not limited to the steps as shown in FIG. 2. Referring to FIG. 6, FIG. 6 is another flow diagram of the control method 200 in accordance with some embodiments of the present disclosure. In some embodiments, as shown in FIG. 6, the control method 200 further includes operation S601.

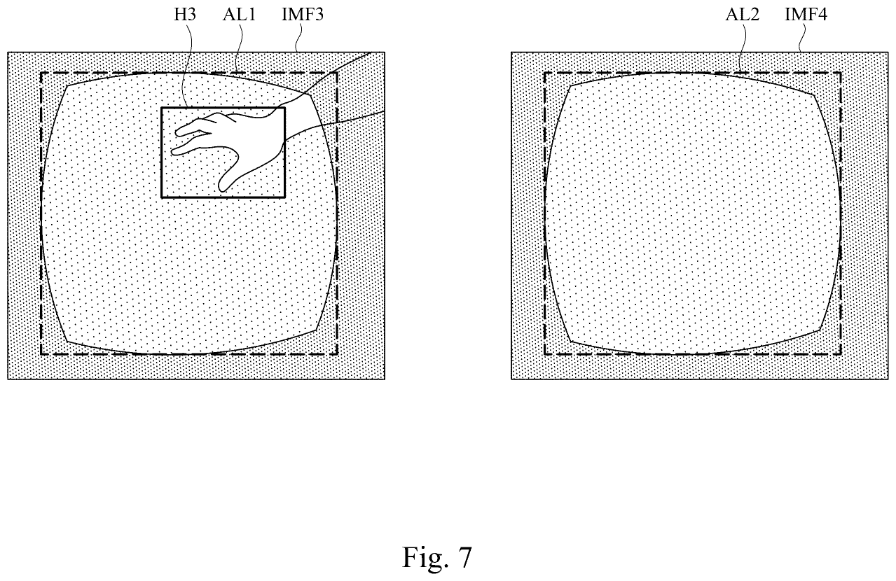

In operation S601, the processor 11 determines if the hand of the user U1 is within an illumination area of the supplemental lighting system 15. In some embodiments, the processor 11 performs some existing image recognitions on the image frame captured by the camera 13 to determine if the hand of the user U1 is within the illumination area of the supplemental lighting system 15, which would be described with reference to FIG. 7. FIG. 7 is a schematic diagram of an image frame IMF3 and an image frame IMF4, which are captured by the camera 13, in accordance with some embodiments of the present disclosure.

In some embodiments, the processor 11 recognizes a hand image H3 and a light spot image AL1 from the image frame IMF3. In particular, the light spot image AL1 in the image frame IMF3 is corresponding to the illumination area of the supplemental lighting system 15. Because the image recognition result of the image frame IMF3 shows that the hand image H3 is overlapped or within the light spot image AL1, the processor 11 determines the hand of the user U1 is within the illumination area of the supplemental lighting system 15, so that operation S203 is executed.

In some embodiments, the processor 11 recognizes a light spot image AL2 from the image frame IMF4. In particular, the light spot image AL2 in the image frame IMF4 is corresponding to the illumination area of the supplemental lighting system 15. Because the image recognition result of the image frame IMF4 shows that there is no hand image overlapping or within the light spot image AL2, the processor 11 determines the hand of the user U1 is not within the illumination area of the supplemental lighting system 15, so that operation S205 is directly executed. As should be understood, when the wearable device 100 finds out that the hand of the user U1 is not within the illumination area of the supplemental lighting system 15, the wearable device 100 does not need the supplemental illumination. Thus, the supplemental lighting system 15 can be turned off for saving the power of the wearable device 100.

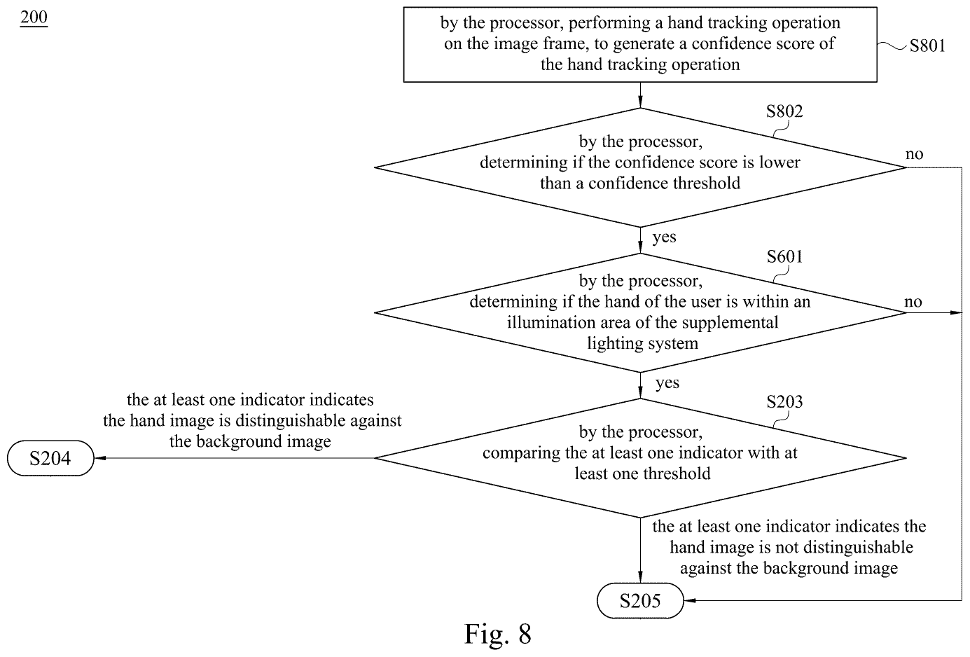

Referring to FIG. 8, FIG. 8 is yet another flow diagram of the control method 200 in accordance with some embodiments of the present disclosure. In some embodiments, as shown in FIG. 8, the control method 200 further includes operations S801 and S802.

In operation S801, the processor 11 performs a hand tracking operation on the image frame, to generate a confidence score of the hand tracking operation. In some embodiments, by some existing hand tracking algorithms, the processor 11 recognizes and tracks the hand image H1 of the image frame IMF1 in FIG. 3, the hand image H2 of the image frame IMF2 in FIG. 3 or the hand image H3 of the image frame IMF3 in FIG. 7, and calculates the confidence score for the hand tracking result of the image frame IMF1, the image frame IMF2 or the image frame IMF3. In particular, the confidence score indicates an accuracy of the hand tracking result.

In operation S802, the processor 11 determines if the confidence score is lower than a confidence threshold. In some embodiments, the processor 11 determines that the confidence score for the hand tracking result of the image frame IMF1 in FIG. 3 is lower than the confidence threshold, so that operation S601 is executed. That is to say, when the wearable device 100 cannot track the hand of user U1 accurately, the wearable device 100 further checks if the hand of the user U1 is within the illumination area of the supplemental lighting system 15.

In some embodiments, the processor 11 determines that the confidence score for the hand tracking result of the image frame IMF2 in FIG. 3 or the image frame IMF3 in FIG. 7 is not lower than the confidence threshold, so that operation S205 is directly executed. In other words, if the wearable device 100 can track the hand of user U1 accurately, the wearable device 100 turns the supplemental lighting system 15 off to save its power.

In addition, in some further embodiments, the camera 13 captures one image frame with the hand image but without the light spot image, that is, said image frame is captured when the supplemental lighting system 15 is turned off or does not emit the supplemental light. In these cases, the processor 11 may determine that the confidence score for the hand tracking result of said image frame is lower than the confidence threshold. Then, the processor 11 can turn the supplemental lighting system 15 on or can control the supplemental lighting system 15 to emit the supplemental light accordingly.

Moreover, the control method 200 of the present disclosure is not limited to steps shown in FIG. 8. For example, in some embodiments, operation S601 is omitted from FIG. 8. Accordingly, when the processor 11 determines that the confidence score for the hand tracking result is lower than the confidence threshold, operation S203 is directly executed. When the processor 11 determines that the confidence score for the hand tracking result is not lower than the confidence threshold, operation S205 is directly executed.

It should be understood that the control method 200 of the present disclosure is not limited to be applied to the wearable device 100. For example, in some embodiments, the control method 200 is applicable to a hand tracking system including the processor 11, the camera 13 and the supplemental lighting system 15.

In the above embodiments, the processor 11 can be implemented by a central processing unit (CPU), an application-specific integrated circuit (ASIC), a microprocessor, a system on a Chip (SoC) or other suitable processing circuits. The supplemental lighting system 15 can be implemented by a visible light source, an invisible light source, or both. The sensor 19 can be implemented by a visible light sensor, an invisible light sensor, or both. The display panel 17 can be implemented by an active matrix organic light emitting diode (AMOLED) display, an organic light emitting diode (OLED) display, or other suitable displays.

As can be seen from the above embodiments of the present disclosure, in the condition that the low confidence score of the hand tracking result is caused not because the hand of the user U1 is not within the illumination area, the wearable device 100 determines if the quality of the image frame related to the hand of the user U1 would affect the hand tracking through the at least one indicator (e.g., the discrimination rate RD, the focus rates RFH and RFW, etc.), and stops providing the supplemental illumination when the image frame with low quality due to the supplemental illumination would affect the hand tracking. That is to say, the wearable device 100 and the control method 200 of the present disclosure have advantages of high reliability of the hand tracking.

The disclosed methods, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the at least one processor to provide a unique apparatus that operates analogously to application specific logic circuits.

Although the present disclosure has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present disclosure without departing from the scope or spirit of the invention. In view of the foregoing, it is intended that the present invention cover modifications and variations of this invention provided they fall within the scope of the following claims.

What is claimed is:

1. A control method, configured to control a supplemental lighting system of a wearable device operable by a user, and comprising:
by a camera of the wearable device, capturing an image frame related to a hand of the user;
by a processor of the wearable device, generating at least one indicator according to the image frame; and
by the processor, selectively maintaining an enablement of the supplemental lighting system based on the at least one indicator indicating whether a hand image in the image frame is distinguishable against a background image of the image frame.

2. The control method of claim 1, wherein generating the at least one indicator according to the image frame comprises:
performing a statistical calculation on the image frame, to generate a statistical result indicating an amount of each of a plurality of pixel values;
obtaining a mode in a preset pixel value range from the statistical result; and
calculating a discrimination rate according to the mode in the preset pixel value range.

3. The control method of claim 1, wherein generating the at least one indicator according to the image frame comprises:
performing a statistical calculation on the image frame, to generate a plurality of statistical results indicating an amount and a distribution of a plurality of highlight pixels in the image frame;
obtaining a plurality of modes from the plurality of statistical results; and
calculating a plurality of focus rates according to the plurality of modes and the plurality of statistical results.

4. The control method of claim 1, further comprising:
by the processor, comparing the at least one indicator with at least one threshold, to determine whether the hand image is distinguishable against the background image,
wherein the processor maintains the enablement of the supplemental lighting system in response to the at least one indicator indicating the hand image is distinguishable against the background image, and deactivates the supplemental lighting system in response to the at least one indicator indicating the hand image is not distinguishable against the background image.

5. The control method of claim 4, wherein the at least one indicator includes a discrimination rate, the at least one threshold includes a discrimination rate threshold, and comparing the at least one indicator with the at least one threshold comprises:
by the processor, comparing the discrimination rate with the discrimination rate threshold,
wherein when the discrimination rate is higher than the discrimination rate threshold, the processor determines that the hand image is distinguishable against the background image, and when the discrimination rate is not higher than the discrimination rate threshold, the processor determines that the hand image is not distinguishable against the background image.

6. The control method of claim 4, wherein the at least one indicator includes a plurality of focus rates, the at least one threshold includes a focus rate threshold, and comparing the at least one indicator with the at least one threshold comprises:
by the processor, comparing the plurality of focus rates with the focus rate threshold,
wherein when each of the plurality of focus rates is lower than the focus rate threshold, the processor determines that the hand image is distinguishable against the background image, and when at least one of the plurality of focus rates is not lower than the focus rate threshold, the processor determines that the hand image is not distinguishable against the background image.

7. The control method of claim 4, further comprising:
by the processor, determining if the hand of the user is within an illumination area of the supplemental lighting system based on an image recognition result of the image frame,
wherein the processor compares the at least one indicator with the at least one threshold when the hand of the user is within the illumination area.

8. The control method of claim 7, further comprising:
when the hand of the user is not within the illumination area, by the processor, deactivating the supplemental lighting system.

9. The control method of claim 4, further comprising:
by the processor, performing a hand tracking operation on the image frame, to generate a confidence score of the hand tracking operation; and
by the processor, determining if the confidence score is lower than a confidence threshold, wherein the processor compares the at least one indicator with the at least one threshold when the confidence score is lower than the confidence threshold.

10. The control method of claim 9, further comprising:
when the confidence score is not lower than the confidence threshold, by the processor, deactivating the supplemental lighting system.

11. A wearable device, operable by a user, and comprising:
a supplemental lighting system, configured to emit a supplemental light;
a camera, configured to capture an image frame related to a hand of the user; and
a processor, coupled to the supplemental lighting system and the camera, and configured to:
generate at least one indicator according to the image frame; and
selectively maintain an enablement of the supplemental lighting system based on the at least one indicator indicating whether a hand image in the image frame is distinguishable against a background image of the image frame.

12. The wearable device of claim 11, wherein the processor is configured to:
perform a statistical calculation on the image frame, to generate a statistical result indicating an amount of each of a plurality of pixel values;
obtain a mode in a preset pixel value range from the statistical result; and
calculate a discrimination rate according to the mode in the preset pixel value range.

13. The wearable device of claim 11, wherein the processor is configured to:
perform a statistical calculation on the image frame, to generate a plurality of statistical results indicating an amount and a distribution of a plurality of highlight pixels in the image frame;
obtain a plurality of modes from the plurality of statistical results; and
calculate a plurality of focus rates according to the plurality of modes and the plurality of statistical results.

14. The wearable device of claim 11, wherein the processor is further configured to compare the at least one indicator with at least one threshold, to determine whether the hand image is distinguishable against the background image,
wherein the processor maintains the enablement of the supplemental lighting system in response to the at least one indicator indicating the hand image is distinguishable against the background image, and deactivates the supplemental lighting system in response to the at least one indicator indicating the hand image is not distinguishable against the background image.

15. The wearable device of claim 14, wherein the at least one indicator includes a discrimination rate, the at least one threshold includes a discrimination rate threshold, and the processor is configured to compare the discrimination rate with the discrimination rate threshold,
wherein when the discrimination rate is higher than the discrimination rate threshold, the processor determines that the hand image is distinguishable against the background image, and when the discrimination rate is not higher than the discrimination rate threshold, the processor determines that the hand image is not distinguishable against the background image.

16. The wearable device of claim 14, wherein the at least one indicator includes a plurality of focus rates, the at least one threshold includes a focus rate threshold, and the processor is configured to compare the plurality of focus rates with the focus rate threshold,
wherein when each of the plurality of focus rates is lower than the focus rate threshold, the processor determines that the hand image is distinguishable against the background image, and when at least one of the plurality of focus rates is not lower than the focus rate threshold, the processor determines that the hand image is not distinguishable against the background image.

17. The wearable device of claim 14, wherein the processor is further configured to determine if the hand of the user is within an illumination area of the supplemental lighting system based on an image recognition result of the image frame,
wherein the processor compares the at least one indicator with the at least one threshold when the hand of the user is within the illumination area.

18. The wearable device of claim 17, wherein when the hand of the user is not within the illumination area, the processor deactivates the supplemental lighting system.

19. The wearable device of claim 14, wherein the processor is further configured to:
perform a hand tracking operation on the image frame, to generate a confidence score of the hand tracking operation; and
determine if the confidence score is lower than a confidence threshold,
wherein the processor compares the at least one indicator with the at least one threshold when the confidence score is lower than the confidence threshold, and when the confidence score is not lower than the confidence threshold, the processor deactivates the supplemental lighting system.

20. A non-transitory computer readable storage medium with a computer program to execute a control method, wherein the control method is configured to control a supplemental lighting system of a wearable device operable by a user, and comprises:
by a camera of the wearable device, capturing an image frame related to a hand of the user;
by a processor of the wearable device, generating at least one indicator according to the image frame; and
by the processor, selectively maintaining an enablement of the supplemental lighting system based on the at least one indicator indicating whether a hand image in the image frame is distinguishable against a background image of the image frame.
